(19) United States
(12) Patent Application Publication
(10) Pub. No.: US 2007/0052575 A1
(43) Pub. Date: Mar. 8, 2007

(54) Near-field electromagnetic wave absorber

(75) Inventors: Takamitsu Nakagomi, Yamanashi (JP); Masahiro Kouno, Yamanashi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: NISCA Corporation, Yamanashi (JP)

(21) Appl. No.: 11/512,784

(22) Filed: Aug. 30, 2006

(30) Foreign Application Priority Data
Aug. 30, 2005 (JP) 2005-250341
Jul. 7, 2006 (JP) 2006-188005

(51) Int. Cl. H01Q 17/00

(52) U.S. Cl. 342/1; 342/2

(57) ABSTRACT

An object of the present invention is to provide a near field electromagnetic absorber that is capable of expressing an effective electromagnetic wave absorption characteristic in a broad range of frequency bands by using conductive material that conductively acts on the electrical field component of an electromagnetic wave. The present invention discloses a near-filed electromagnetic wave absorber consisting essentially of conductive material, wherein the near-field electromagnetic wave absorber absorbs an electromagnetic wave within one wavelength from the electromagnetic wave source by the conductive material, which conductively acts on the electrical field component of the electromagnetic wave.

### BACKGROUND OF THE INVENTION

1. Field of the Invention

The present invention relates to a near-field electromagnetic wave absorber. The present invention relates to a near-field electromagnetic wave absorber having a sufficient absorption characteristic especially against an electromagnetic wave having a frequency range of several hundred MHz to 1 GHz or more.

2. Description of Related Art

Conventionally, various kinds of electromagnetic wave absorbers, which suppress interference of the electromagnetic wave by absorbing an unnecessary electromagnetic wave from the noise source, have been proposed and put into practical use, in order to prevent malfunction of an electronic apparatus due to the unnecessary electromagnetic wave that is an unintended noise released from a communication apparatus and various kinds of electronic apparatuses.

Electromagnetic wave absorbing materials of the electromagnetic wave absorbers may include materials using a magnetic substance (for example, see Patent Document 1), materials using a dielectric substance or a magnetic substance and a dielectric substance (for example, see Patent Document 2), materials using a conductive substance (for example, see Patent Document 3) and the like. Among them, a proper material is selected and used, depending on the environment, the purpose of use, and the like.

On the other hand, with the advance of communication technology and digital technology in recent years, greater capacity and higher speed of transmit data, for instance, are desired. In order to satisfy the demands, the CPU clock frequency of cellular phones and computers has been increasing, and accompanying it, the frequency of the unnecessary electromagnetic waves from the noise sources has been increasing from the MHz range to the GHz range. Further, there has been desired for a near-field electromagnetic wave absorber that effectively absorbs an unnecessary electromagnetic wave from a noise source in the environment of a small space where various kinds of electromagnetic wave generating sources are close to each other, since miniaturization and reduction in weight of these apparatuses have advanced at the same time.

Meanwhile, since the wave impedances of a far electromagnetic field and a near electromagnetic field are different and the magnetic field is dominant in a near electromagnetic field (an electromagnetic field in which a strong magnetic field component is dominant), a magnetic substance (for example, see Patent Document 1) has been generally used as the material for a near-field electromagnetic wave absorber. An electromagnetic wave of predetermined frequency range is absorbed by, for example, adjusting permeability to act on the magnetic field.

Moreover, recently, a technique using conductive powder as a near-field electromagnetic absorber in place of the magnetic substance (magnetic powder) has been proposed (for example, see Patent Document 4).

[Patent Document 1] Japanese Patent Application Laid-Open (JP-A) No. 2001-126904

[Patent Document 2] JP-A No. 2004-336028

[Patent Document 3] JP-A No. 2005-85966

[Patent Document 4] JP-A No. 2005-11878

Although the technique in Patent Document 1, wherein a magnetic substance is used, shows a sufficient absorption characteristic against unnecessary electromagnetic waves of a frequency range of 3 GHz or thereabout, it does not show a sufficient absorption characteristic against a frequency range of several hundred MHz to 1 GHz or more where EMI countermeasures are currently most needed. Also, the method for preparing an electromagnetic wave absorber by dispersing the magnetic particles uniformly in the substrate is not easy, and the manufacturing cost cannot avoid being high. Moreover, since it is necessary to use a metal magnetic substance having a high permeability for the near electromagnetic field, it is difficult to use inexpensive materials such as a ferrite with low permeability, resulting in problems such as the cost of material itself also being high.

Additionally, a conductive powder is used for the electromagnetic wave absorber of Patent Document 4 instead of the magnetic substance (magnetic powder). Although the absorber takes a technique using a dielectric substance which acts on an electrical field, its electromagnetic wave absorption characteristic is not sufficient or is uncertain.

### BRIEF SUMMARY OF THE INVENTION

An object of the present invention is to provide a near-field electromagnetic absorber that is capable of expressing an effective electromagnetic wave absorption characteristic in a broad range of frequency bands by using conductive material, which conductively acts on the electrical field component of an electromagnetic wave.

Further, in addition to the above-described object, another object of the present invention is to provide an inexpensive near-field electromagnetic wave absorber.

More, in addition to the above-described objects, an object of the present invention is to provide a near-field electromagnetic wave absorber wherein the manufacturing method is easy and the manufacturing cost is reduced.

The present inventors have found that the above-mentioned objects can be achieved by following inventions:

<1> A near-field electromagnetic wave absorber consisting essentially of a conductive material, wherein the conductive material conductively acts on the electrical field component of the electromagnetic wave, and thereby the conductive material absorbs an electromagnetic wave within one wavelength from the electromagnetic wave source.

<2> In the above item <1>, the near-field electromagnetic wave absorber may further comprise a substrate, and the conductive material may be formed on the surface or inside of the substrate.

<3> n the above item <2>, the substrate may comprise non-metallic material.

<4> In anyone of the above items <1> to <3>, the surface resistivity of the surface of the conductive material may range from 3 to 190 Ω/□.

<5> In anyone of the above items <1> to <4>, the surface resistivity of the surface of the conductive material may range from 4 to 70 Ω/□.

<6> In any one of the above items <1> to <4>, the surface resistivity of the surface of the conductive material may range from 10 to 190 Ω/□.

<7> In any one of the above items <1> to <4> and <6>, the surface resistivity of the surface of the conductive material may range from 10 to 80 Ω/□.

<8> In any one of the above items <1> to <7>, the conductive material may comprise carbon-based materials.

<9> In any one of the above items <1> to <8>, the conductive material may have a form of powder, fine powder, lump, whisker, flat, or fiber.

<10> In any one of the above items <1> to <9>, the conductive material may comprise at least either of carbon nano-fiber or carbon nano-tube.

<11> In the above item <10>, the conductive material may comprise carbon black or carbon graphite.

<12> In any one of the above items <1> to <11>, the conductive material may comprise at least carbon nano-fiber and the surface density of the carbon nano-fiber may range from 0.3 to 9 mg/cm².

### BRIEF DESCRIPTION OF DRAWINGS

FIG. 1 is a schematic view of a device for measuring transmission attenuation of an electromagnetic wave absorber;

FIG. 2 is a graph showing the absorption characteristic (transmission attenuation) depending on frequency of an electromagnetic wave for the electromagnetic wave absorber in Example 1 and the comparative sample in Comparative Example 1;

FIG. 3 is a graph showing the absorption characteristic (transmission attenuation) against an electromagnetic wave of 1 GHz frequency for the electromagnetic wave absorber in Example 1 (surface resistivity is 3.3 to 190 Ω/□);

FIG. 4 is a graph showing the absorption characteristic (transmission attenuation) against an electromagnetic wave of 1 GHz frequency for the electromagnetic wave absorber in Example 1 wherein the surface resistivity is about 3.3 to 27 Ω/□;

FIG. 5 is a graph showing the absorption characteristic (transmission attenuation) depending on frequency of an electromagnetic wave for the electromagnetic wave absorber in Example 2 and the comparative sample in Comparative Example 1; and,

FIG. 6 is a graph showing the absorption characteristic (transmission attenuation) against an electromagnetic wave of 1 GHz frequency for the electromagnetic wave absorber in Example 2 (the surface resistivity is 5 to 80 Ω/□ and the thickness of the double-faced tape is 20 to 80 μm.).

### DETAILED DESCRIPTION OF INVENTION

The present invention will be described in detail hereinafter.

The present invention provides a near-field electromagnetic wave absorber consisting essentially of conductive material, which absorbs an electromagnetic wave within one wavelength from the electromagnetic wave source by the conductive action of the conductive material on the electrical field component of the electromagnetic wave.

The phrase “consisting essentially of conductive material” used herein means that the near-field electromagnetic wave absorber may have other component(s) or element(s), as long as it contains conductive material, and that the other component(s) or element(s) do not interfere with “the conductive action of the conductive material on the electrical field component of the electromagnetic wave”.

Furthermore, the phrase “to act on the electrical field component of an electromagnetic wave” used herein means that the space distribution of the electrical field is changed by influencing the electrical field component of the electromagnetic wave, and these actions include a conductive action and a dielectric action. Especially, according to the present invention, it means that the strength of the electrical field is attenuated by the conductive action in the state where particles of the conductive material are contacting each other. The dielectric action, which is different from the action according to the present invention, means that the strength of the electrical field is attenuated by the dielectric action in the insulating state where particles of the conductive material are separated from each other.

On the other hand, other than action on “the electrical field component of the electromagnetic wave”, there is an action on “the magnetic field component of the electromagnetic wave”. The phrase “to act on the magnetic field component” means that the space distribution of the magnetic field is attenuated by influencing the magnetic field component of the electromagnetic wave, and, for example, that the strength of the magnetic field is attenuated by using magnetic materials.

The conductive material may exist on the surface region of the electromagnetic wave absorber and the surface region may be positioned facing against the direction of the electromagnetic wave.

The electromagnetic wave absorber may have a substrate, and the conductive material may be formed on the surface or inside of the substrate. Further, the electromagnetic wave absorber may be made of the conductive material itself.

When the electromagnetic wave absorber has a substrate, the substrate is not limited, as long as it does not act on the electromagnetic wave. The substrate may consist of, but is not limited to, non-metal material such as various kinds of paper and various kinds of resin.

The surface resistivity of the surface of the conductive materials may be 3 to 190 Ω/□, preferably 10 to 190 Ω/□, and for example, more preferably 4 to 70 Ω/□ or more preferably 10 to 80 Ω/□.

When the surface resistivity is too low, the conductive material tends to act as an electromagnetic wave shield. That is, the surface resistivity may be in the above-described range, since the material tends to reflect almost all electromagnetic waves.

When the surface resistivity is too high, there may be a tendency that the interference to the electromagnetic wave decreases. Thus, the surface resistivity may be in the above-described range.

The conductive material is not limited, as long as it has the above-described action, especially the above-described surface resistivity. The material may be made of carbon-based material.

The form of the conductive material is not limited, as long as it has the above-described action, especially the above-described surface resistivity. Examples of the form of the conductive material may include, but are not limited to, powder, fine powder, lump, whisker, flat, and fiber.

When the conductive material is carbon-based material, examples may include, but are not limited to, carbon nano-fiber, carbon nano-tube, carbon black, carbon graphite, and fullerene.

Especially, the conductive material may comprise carbon nano-fiber or carbon nano-tube, or both. In addition to the carbon nano-fiber and/or carbon nano-tube, the conductive material may comprise carbon black or carbon graphite.

The amount of the conductive material may be 1.4 to 27 mg/cm² at the surface region of the electromagnetic wave absorber. The conductive material can be constructed including carbon nano-fiber and carbon black or carbon graphite. Especially, the conductive material may include at least carbon nano-fiber, and the surface density of the carbon nano-fiber may be 0.3 to 9 mg/cm².

The near-field electromagnetic wave absorber according to the present invention may have an adhesive layer on top of the surface region where the conductive materials are formed. The near-field electromagnetic wave absorber having an adhesive layer can be used to absorb an unnecessary electromagnetic wave by adhering of the absorber to desired apparatus or product through the adhesive layer.

The electromagnetic wave absorber according to the present invention can be prepared, for example, by the method described as follows:

That is, a substrate such as the above-described paper is prepared. In addition to the preparation of the substrate, a dispersion solution in which the conductive materials is dispersed, for example, a dispersion solution of carbon nano-fiber, is prepared. The dispersion solution is applied onto the substrate while controlling the amount to be applied in order for the resulting electromagnetic wave absorber to have the desired characteristic. Then, the applied substrate is dried, to obtain the desired electromagnetic wave absorber. Furthermore, the above-mentioned method is one example and the method is not limited to it.

### EXAMPLES

Hereinafter, the present invention will be illustrated in more detail by way of Examples, but is not limited thereto.

### Example 1

<Preparation of an Electromagnetic Wave Absorber>

As a substrate, materials described in Table 1 were used. A dispersion solution, with the mass ratio of a carbon black (CB) to a carbon nano-fiber (CNF) described in Table 2, was prepared. The dispersion solution described in Table 2 was applied onto the substrate described in Table 1, while controlling the amount to be applied, and then the applied substrate was dried, to prepare an electromagnetic wave absorber. The surface density of conductive material, i.e. the carbon component, at the surface of the resulting electromagnetic wave absorber was measured.

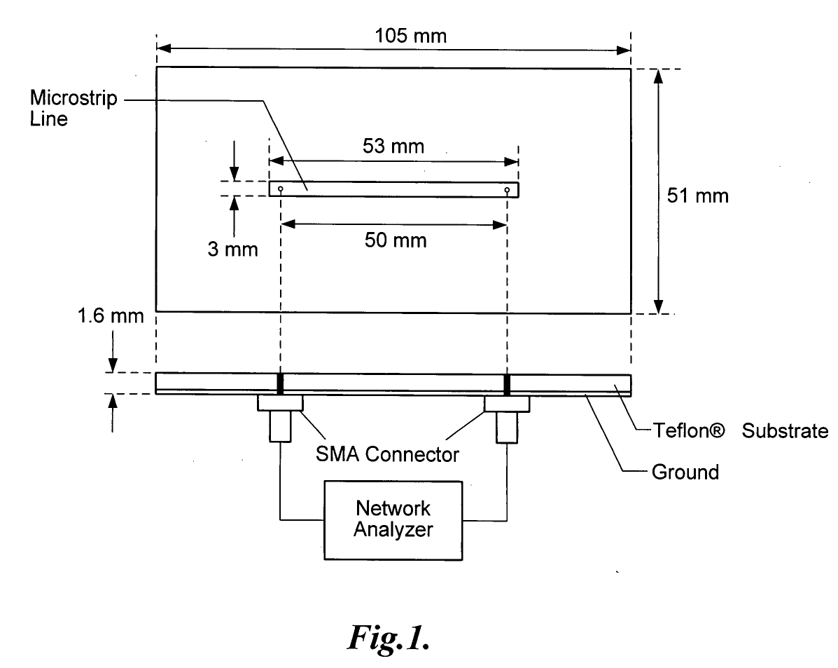

The transmission attenuation of the resulting electromagnetic wave absorber was measured in accordance with IEC TC51 WG10 standards. The measurement device was configured with a network analyzer (abbreviated hereinafter as “NA”) and a 50 Ω microstrip line (abbreviated hereinafter as “MSL”) as shown in FIG. 1.

The electromagnetic wave absorber prepared in size same as the MSL substrate (50 mm×100 mm), was adhered onto and brought into close contact with the MSL with double-faced tape (thickness: 80 μm) such that the surface applied with the dispersion solution faces toward the MSL side. In this state, S₁₁ and S₂₁ of the MSL were measured with the NA. From the measured S₁₁ and S₂₁, the transmission attenuation Rₜₚ was calculated by the following formula:
Rₜₚ=−10×log {10^{S21/10}/(1−10^{S11/10})}.

### Comparative Example 1

A composite magnetic substance formed by sandwiching both sides of a non-magnetic layer with soft-magnetic layers, which is disclosed in Example 1 of JP-A No. 2001-284108, was used as a comparative sample. Specifically, a sheet comprising graphite powder 100 parts by weight and butyl rubber 100 parts by weight as an organic binder was used as a non-magnetic layer, and a sheet comprising Fe—Si—Al metal alloy powder 273 parts by weight and butyl rubber 100 parts by weight was used as a soft-magnetic layer. The transmission attenuation was measured as well on the comparative sample in the same manner as in Example 1 (thickness of double-faced tape: 80 μm).

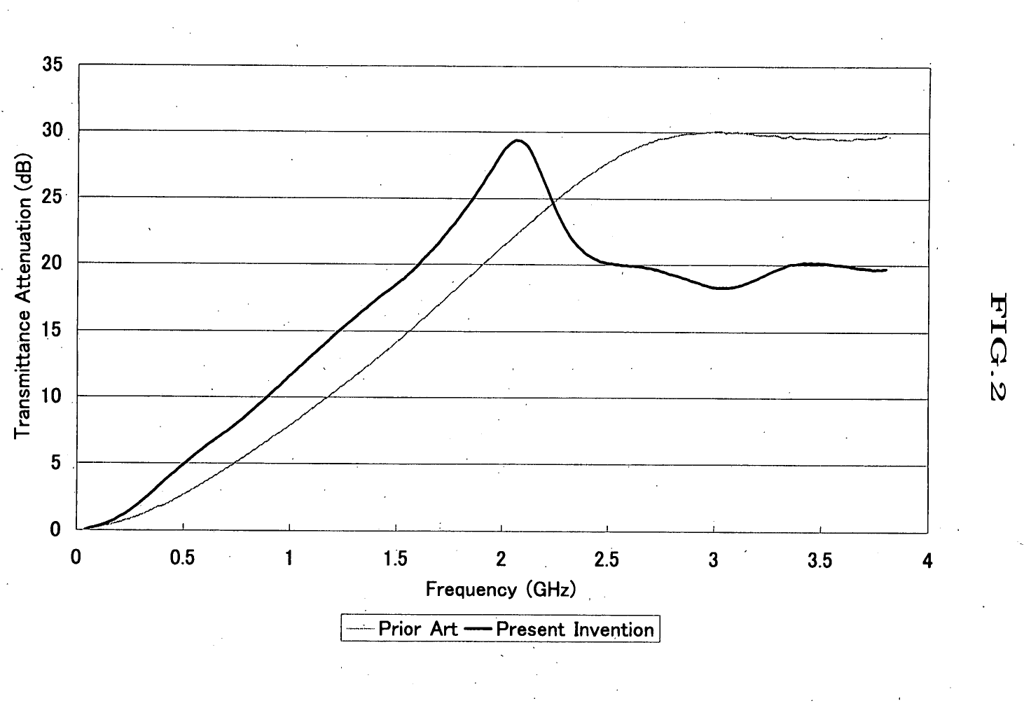

The results are shown in FIGS. 2 to 4 and Tables 3 to 5.

FIG. 2 is a graph showing the absorption characteristic (transmission attenuation) depending on frequency of an electromagnetic wave, for the electromagnetic wave absorber using a substrate B and a dispersing agent 4 wherein the surface resistivity is 5.16 Ω/□ (described as “Present Invention” in FIG. 2), and the comparative sample in Comparative Example 1 (described as “Prior Art” in FIG. 2).

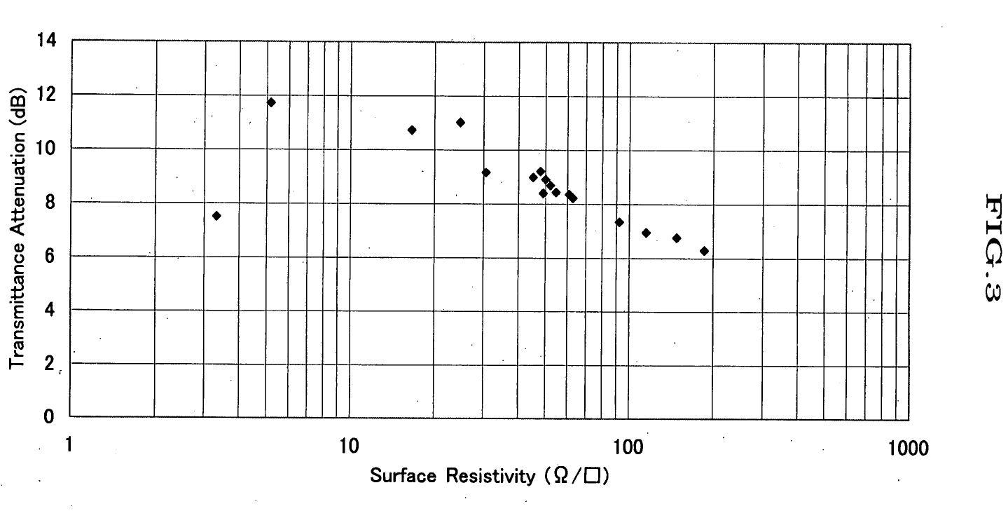

FIG. 3 is a graph showing the absorption characteristic (transmission attenuation) for an electromagnetic wave of 1 GHz frequency where the electromagnetic wave absorber is using substrate B and dispersion agent 4 wherein the surface resistivity is varied (surface resistivity ranges from 3.3 to 190 Ω/□).

Tables 3 to 5 show the absorption characteristic (transmission attenuation) for an electromagnetic wave of 1 GHz frequency with combinations of the substrate and the dispersion substance used to prepare the electromagnetic wave absorber, and combinations thereof and the surface resistivity. Tables 3 and 4 show the surface density of the carbon component used.

FIG. 2 shows that the electromagnetic wave absorber according to the present invention has a higher absorption characteristic than the conventional absorber in the frequency range of about 40 MHz to about 2.2 GHz. FIG. 2 especially shows that the electromagnetic wave absorber according to the present invention has a transmission attenuation of 8 dB to 11 dB in the frequency range of about 700 MHz to 1 GHz or more wherein a sufficient absorption characteristic is desired. Therefore, the electromagnetic wave absorber according to the present invention has a sufficient absorption characteristic in the frequency range of 700 MHz to 1 GHz or more. Generally, when the transmission attenuation is 6 dB or more in a near electromagnetic field, it is recognized that the absorber has a sufficient absorption characteristic.

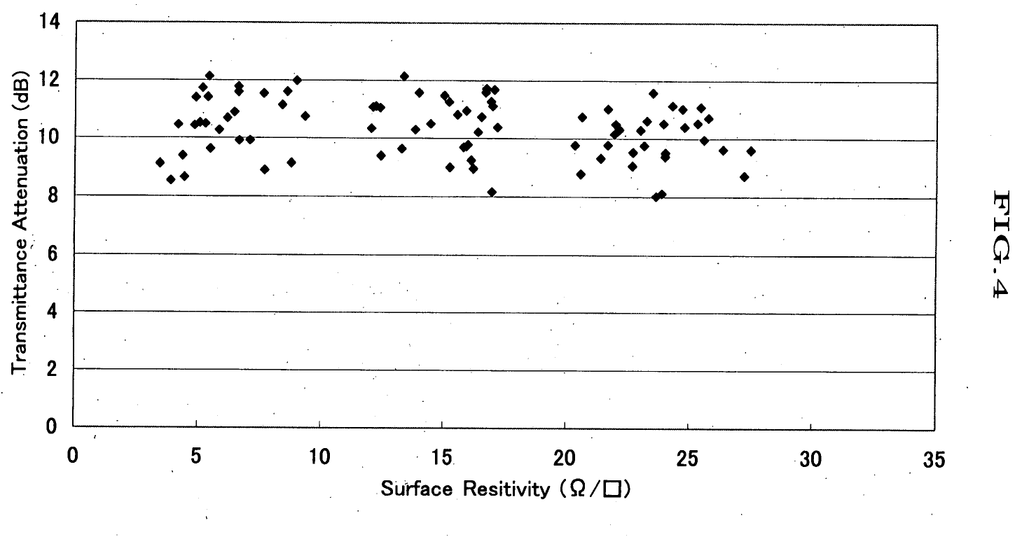

FIG. 3 shows that the electromagnetic wave absorber having a surface resistivity of 3.3 to 190 Ω/□ has a transmission attenuation of 6 dB or more against an electromagnetic wave of 1 GHz. FIG. 3 also shows that the electromagnetic wave absorber having a surface resistivity of 4 to 70 Ω/□ has a transmission attenuation of 8 dB or more against an electromagnetic wave of 1 GHz. Similarly, FIG. 4 shows that the electromagnetic wave absorber having a surface resistivity of 4 to 28 Ω/□ has a transmission attenuation of 8 dB or more against an electromagnetic wave of 1 GHz. Therefore, the electromagnetic wave absorber according to the present invention has a sufficient absorption characteristic against an electromagnetic wave of 1 GHz.

### Example 2

<Preparation of an Electromagnetic Wave Absorber>

An electromagnetic wave absorber was prepared in a manner similar to in Example 1 except that “B” (No. 2 filter paper for production, manufactured by ADVANTEC TOYO KAISHA LTD.) described in Table 1 was used as a substrate, and that “4” (a mass ratio of CB/CNF=1) described in Table 2 was used as dispersion solution.

The transmission attenuation of the resulting electric wave absorber was measured in the same manner as in Example 1. The thickness of the double-faced tape used in the measurement was 20, 30, 50, 80 μm, respectively, as shown in Table 6.

Table 6 shows the surface resistivity and the transmission attenuation of the resulting electric wave absorber with the thickness of the double-faced tape used in the measurement.

Table 7 shows the transmission attenuation against an electromagnetic wave of 1 GHz depending on the thickness of the double-faced tape used in the measurement.

Further, Table 8 shows the maximum value of reflection S₁₁ (dB) for an electromagnetic wave of 1 to 3.8 GHz depending on the thickness of the double-faced tape used in the measurement. Furthermore, S₁₁ is the value of the reflection of an electrical signal that occurs when the electromagnetic wave absorber is put close to or adhered onto a transmission line, and it is preferable for an electromagnetic wave absorber to have a smaller value. Especially, S₁₁ is preferably −6 dB or less.

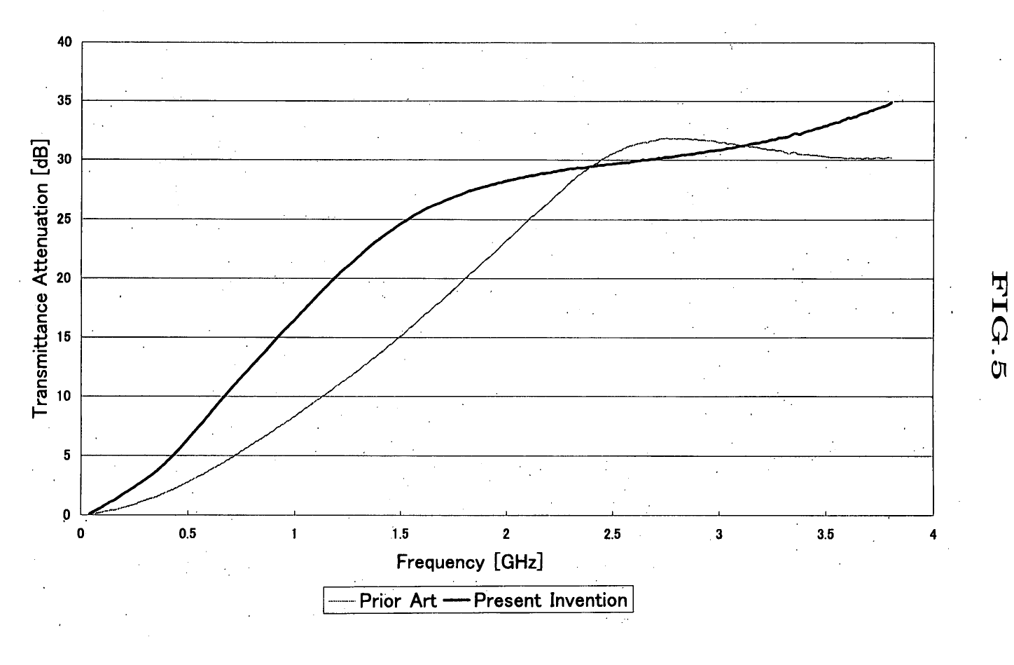

FIG. 5 is a graph showing the absorption characteristic (transmission attenuation) depending on frequency of an electromagnetic wave, for the electromagnetic wave absorber obtained in Example 2 wherein the surface resistivity is 25 (thickness of the double-faced tape: 20 μm) (described as “Present Invention” in FIG. 5), and the comparative sample in Comparative Example 1 (described as “Prior Art” in FIG. 5).

FIG. 5 shows that the electromagnetic wave absorber according to the present invention has a higher absorption characteristic than the conventional absorber in the frequency range of about 40 MHz to about 2.4 GHz and about 3.1 GHz to 3.8 GHz. FIG. 5 especially shows that the electromagnetic wave absorber according to the present invention has a transmission attenuation of 10 dB to 16 dB in the frequency range of about 700 MHz to 1 GHz or more wherein a sufficient absorption characteristic is desired. Therefore, the electromagnetic wave absorber according to the present invention has a sufficient absorption characteristic in the frequency range of 700 MHz to 1 GHz or more. Generally, when the transmission attenuation is 6 dB or more in a near electromagnetic field, it is recognized that the absorber has a sufficient absorption characteristic.

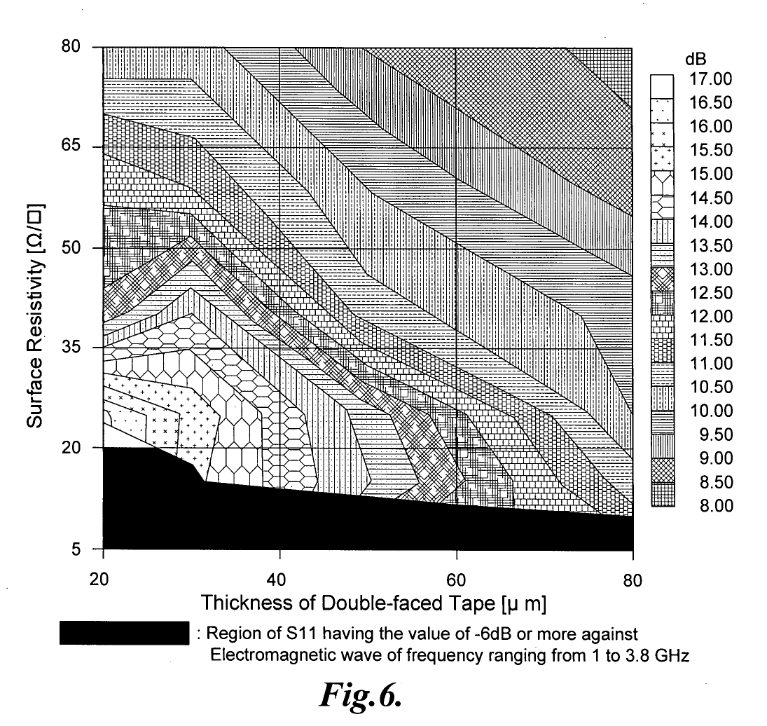

FIG. 6 is a graph showing that the transmission attenuation against an electromagnetic wave of 1 GHz is expressed by brightness, where the vertical axis is the surface resistivity [Ω/□] and the horizontal axis is the thickness of the double-faced tape [μm] used in the measurement. When the brightness is high, i.e., the area is white, the transmission attenuation is high. Thus, it has a high performance as an electromagnetic wave absorber. On the other hand, when the brightness is low, i.e., the area is black, the transmission attenuation is low, and thus it does not perform as an electromagnetic wave absorber.

FIG. 6 shows that the transmission attenuation is high when the surface resistivity is around 20 Ω/□ and the thickness of the double-faced tape is around 20 μm, and from the point, the transmission attenuation decreases radially. Therefore, an electromagnetic wave absorber having high transmission attenuation and high performance can be provided when the surface resistivity is around 20 Ω/□ and the thickness of the double-faced tape is around 20 μm and in the vicinity thereof.

TABLE 1
Substrate

| | |
|---|---|
| A | FUJI XEROX OFFICE SUPPLY |
| | PPC Paper P 64 g/m² |
| B | ADVANTEC TOYO |
| | No. 2 Filter Paper for Production |
| C | Japanese Paper |
| | Kurotani 10 monme |
| D | Japanese Paper |
| | Echizen MO Paper |
| E | ADVANTEC TOYO |
| | No. 63F Filter Paper for Production |
| F | Optima Co., Ltd. |
| | OHP Film NIJA 4-10 OHP |

TABLE 2

| Dispersion solution | CB/CNF (Weight ratio) |
|---|---|
| 1 | 0 |
| 2 | 0.4 |
| 3 | 0.6 |
| 4 | 1 |
| 5 | 1.67 |
| 6 | 3.75 |

TABLE 3

| Parameter | | Surface | Transmission | Surface Density (mg/cm2) | | | |
|---|---|---|---|---|---|---|---|
| | Dispersion | Resistivity | Attenuation | | Total | | |
| Substrate | Solution | [Ω/□] | [dB](1 GHz) | Total | Carbon | CB | CNF |
| A. FUJI XEROX OFFICE | 1 | 15.55 | 10.83 | — | — | — | — |
| SUPPLY | | 21.94 | 10.16 | — | — | — | — |
| PPC Paper P 64 g/m2 | 2 | 5.83 | 10.27 | — | — | — | — |
| | | 13.34 | 12.14 | — | — | — | — |
| | | 25.44 | 11.10 | — | — | — | — |
| | 3 | 4.88 | 11.41 | — | — | — | — |
| | | 13.98 | 11.58 | — | — | — | — |
| | | 24.29 | 11.15 | — | — | — | — |
| | 4 | 8.60 | 11.62 | — | — | — | — |
| | | 16.73 | 11.73 | — | — | — | — |
| | | 22.99 | 10.30 | — | — | — | — |
| | 5 | 8.98 | 11.99 | — | — | — | — |
| | | 15.01 | 11.49 | — | — | — | — |
| | | 21.68 | 11.03 | — | — | — | — |
| | 6 | 6.17 | 10.70 | — | — | — | — |
| | | 17.05 | 11.69 | — | — | — | — |
| | | 23.49 | 11.60 | — | — | — | — |
| B. ADVANTEC TOYO | 1 | 12.03 | 10.34 | 24.93 | 8.31 | 0.00 | 8.31 |
| No. 2 Filter Paper for | | 21.40 | 9.32 | 10.53 | 3.51 | 0.00 | 3.51 |
| Production | 2 | 4.44 | 8.66 | 16.33 | 9.53 | 2.72 | 6.81 |
| | | 13.26 | 9.63 | 9.53 | 5.56 | 1.59 | 3.97 |
| | | 23.14 | 9.76 | 6.93 | 4.05 | 1.16 | 2.89 |
| | 3 | 5.06 | 10.53 | 15.73 | 9.49 | 3.56 | 5.93 |
| | | 15.93 | 9.72 | — | — | — | — |
| | | 22.66 | 9.07 | 8.93 | 5.39 | 2.02 | 3.37 |
| | 4 | 5.16 | 11.73 | 12.53 | 7.71 | 3.86 | 3.86 |
| | | 16.53 | 10.75 | 3.73 | 2.30 | 1.15 | 1.15 |
| | | 24.70 | 11.04 | 2.73 | 1.68 | 0.84 | 0.84 |
| | 5 | 6.62 | 11.60 | 9.33 | 5.74 | 3.59 | 2.15 |
| | | 16.92 | 11.29 | 2.33 | 1.44 | 0.90 | 0.54 |
| | | 24.79 | 10.41 | 1.93 | 1.19 | 0.74 | 0.45 |
| | 6 | 5.38 | 11.42 | 13.13 | 8.61 | 6.79 | 1.81 |
| | | 12.39 | 11.06 | 3.13 | 2.05 | 1.62 | 0.43 |
| | | 25.31 | 10.54 | 2.73 | 1.79 | 1.41 | 0.38 |
| C. Japanese Paper | 1 | 12.09 | 11.09 | 26.92 | 8.97 | 0.00 | 8.97 |
| Kurotani 10 monme | | 22.00 | 10.51 | 16.92 | 5.64 | 0.00 | 5.64 |
| | 2 | 4.84 | 10.44 | 13.92 | 8.12 | 2.32 | 5.80 |
| | | 17.18 | 10.39 | 7.52 | 4.39 | 1.25 | 3.13 |
| | | 21.68 | 9.77 | 5.72 | 3.34 | 0.95 | 2.38 |
| | 3 | 7.64 | 11.55 | 14.52 | 8.76 | 3.28 | 5.47 |
| | | 15.21 | 11.27 | 6.32 | 3.81 | 1.43 | 2.38 |
| | | 26.35 | 9.62 | 4.92 | 2.97 | 1.11 | 1.85 |
| | 4 | 5.43 | 12.14 | 8.72 | 5.37 | 2.68 | 2.68 |
| | | 16.70 | 11.59 | 2.92 | 1.80 | 0.90 | 0.90 |
| | | 23.25 | 10.62 | 2.32 | 1.43 | 0.71 | 0.71 |
| | 5 | 6.62 | 11.78 | 8.12 | 5.00 | 3.12 | 1.87 |
| | | 15.92 | 10.96 | — | — | — | — |
| | | 22.14 | 10.32 | 2.32 | 1.43 | 0.89 | 0.54 |
| | 6 | 5.28 | 10.50 | 16.72 | 10.95 | 8.65 | 2.31 |
| | | 16.98 | 11.12 | 6.32 | 4.14 | 3.27 | 0.87 |
| | | 25.75 | 10.73 | 4.72 | 3.09 | 2.44 | 0.65 |

TABLE 4

| Parameter | | Surface | Transmission | Surface Density (mg/cm2) | | | |
|---|---|---|---|---|---|---|---|
| | Dispersion | Resistivity | Attenuation | | Total | | |
| Substrate | Solution | [Ω/□] | [dB](1 GHz) | Total | Carbon | CB | CNF |
| D. Japanese Paper | 1 | 12.21 | 11.12 | 17.24 | 5.75 | 0.00 | 5.75 |
| Echizen MO Paper | | 23.86 | 8.12 | 14.44 | 4.81 | 0.00 | 4.81 |
| | 2 | 3.88 | 8.55 | 21.24 | 12.39 | 3.54 | 8.85 |
| | | 15.25 | 9.01 | 12.04 | 7.02 | 2.01 | 5.01 |
| | | 20.58 | 8.80 | 9.64 | 5.62 | 1.61 | 4.01 |
| | 3 | 4.18 | 10.47 | 14.24 | 8.59 | 3.22 | 5.37 |
| | | 16.12 | 9.24 | 9.84 | 5.93 | 2.22 | 3.71 |
| | | 23.99 | 9.38 | 7.84 | 4.73 | 1.77 | 2.95 |
| | 4 | 6.66 | 9.90 | 3.64 | 2.24 | 1.12 | 1.12 |
| | | 15.99 | 9.77 | 3.64 | 2.24 | 1.12 | 1.12 |
| | | 27.47 | 9.60 | 1.44 | 0.88 | 0.44 | 0.44 |
| | 5 | 8.39 | 11.16 | 8.84 | 5.44 | 3.40 | 2.04 |
| | | 14.46 | 10.51 | 3.44 | 2.11 | 1.32 | 0.79 |
| | | 22.69 | 9.53 | 3.24 | 1.99 | 1.24 | 0.75 |
| | 6 | 6.46 | 10.91 | 5.64 | 3.69 | 2.91 | 0.78 |
| | | 16.40 | 10.22 | 5.24 | 3.43 | 2.71 | 0.72 |
| | | 25.58 | 9.95 | 3.84 | 2.51 | 1.98 | 0.53 |
| E. ADVANTEC TOYO | 1 | 8.77 | 9.14 | 21.32 | 7.11 | 0.00 | 7.11 |
| No. 63F Filter Paper for | | 20.34 | 9.76 | 16.92 | 5.64 | 0.00 | 5.64 |
| Production | 2 | 4.36 | 9.38 | 19.12 | 11.15 | 3.19 | 7.97 |
| | | 16.22 | 8.96 | 6.72 | 3.92 | 1.12 | 2.80 |
| | | 23.92 | 10.53 | 6.52 | 3.80 | 1.09 | 2.72 |
| | 3 | 3.44 | 9.12 | 16.32 | 9.84 | 3.69 | 6.15 |
| | | 13.83 | 10.30 | 2.72 | 1.64 | 0.62 | 1.03 |
| | | 20.63 | 10.76 | 4.92 | 2.97 | 1.11 | 1.85 |
| | 4 | 5.48 | 9.62 | 6.72 | 4.14 | 2.07 | 2.07 |
| | | 16.97 | 8.17 | 7.72 | 4.75 | 2.38 | 2.38 |
| | | 23.63 | 8.02 | 4.32 | 2.66 | 1.33 | 1.33 |
| | 5 | 7.09 | 9.91 | 9.92 | 6.10 | 3.82 | 2.29 |
| | | 12.42 | 9.39 | — | — | — | — |
| | | 27.20 | 8.74 | — | — | — | — |
| | 6 | 7.69 | 8.91 | 15.52 | 10.17 | 8.03 | 2.14 |
| | | 15.81 | 9.69 | 12.32 | 8.07 | 6.37 | 1.70 |
| | | 24.00 | 9.51 | 10.72 | 7.02 | 5.54 | 1.48 |

TABLE 5

Substrate
F

| | Surface | Transmittance |
|---|---|---|
| Conductive | Resistivity | Attenuation |
| Dispersion | (Ω/□) | (dB) |
| 4 | 9.33 | 10.76 |

TABLE 6

Parameter

| | Thickness of | Surface | Transmission |
|---|---|---|---|
| Surface Resistivity | Tape | Resistivity | Attenuation |
| [Ω/□] | [μm] | [Ω/□] | [dB ](1 GHz) |
| 70˜ | 20 | 74.77 | 10.07 |
| | 30 | 83.81 | 10.23 |
| | 50 | 89.08 | 8.98 |
| | 80 | 76.58 | 8.34 |
| 50˜70 | 20 | 57.27 | 11.86 |
| | 30 | 55.82 | 11.36 |
| | 50 | 62.35 | 9.96 |
| | 80 | 67.58 | 8.70 |
| 30˜50 | 20 | 38.82 | 12.65 |
| | 30 | 32.58 | 14.03 |
| | 50 | 46.21 | 10.74 |
| | 80 | 36.54 | 9.83 |
| 20˜30 | 20 | 27.05 | 16.59 |
| | 30 | 27.71 | 15.33 |
| | 50 | 25.83 | 13.27 |
| | 80 | 25.67 | 10.00 |
| 10˜20 | 20 | 15.46 | 16.97 |
| | 30 | 15.71 | 15.14 |
| | 50 | 17.02 | 13.54 |
| | 80 | 17.74 | 10.75 |
| ˜10 | 20 | 6.61 | 16.78 |
| | 30 | 6.42 | 15.93 |
| | 50 | 6.33 | 12.54 |
| | 80 | 6.39 | 11.56 |

TABLE 7
Transmission Attenuation against
Electromagnetic Wave of 1 GHz Frequency

| | |
|---|---|
| Surface | Thickness of Double-faced |
| Resistivity | Tape [μm] |

| [Ω/□] | 20 | 30 | 50 | 80 |
|---|---|---|---|---|
| ˜10 Ω/□ | 16.78 | 15.93 | 12.54 | 11.56 |
| 10˜20 Ω/□ | 16.97 | 15.14 | 13.54 | 10.75 |
| 20˜30 Ω/□ | 16.59 | 15.33 | 13.27 | 10.00 |
| 30˜50 Ω/□ | 12.65 | 14.03 | 10.74 | 9.83 |
| 50˜70 Ω/□ | 11.86 | 11.36 | 9.96 | 8.70 |
| 70˜80 Ω/□ | 10.07 | 10.23 | 8.98 | 8.34 |

TABLE 8
Maximum Value of Reflection S11 for
Electromagnetic Wave at the range from 1 to 3.8 GHz

| | |
|---|---|
| Surface | Thickness of Double-faced |
| Resistivity | Tape [μm] |

| [Ω/□] | 20 | 30 | 50 | 80 |
|---|---|---|---|---|
| ˜10 Ω/□ | −3.36 | −4.68 | −4.52 | −4.69 |
| 10˜20 Ω/□ | −5.24 | −5.96 | −6.50 | −7.40 |
| 20˜30 Ω/□ | −6.11 | −6.13 | −6.39 | −7.58 |
| 30˜50 Ω/□ | −6.23 | −6.98 | −7.33 | −8.01 |
| 50˜70 Ω/□ | −7.59 | −8.55 | −8.36 | −9.52 |
| 70˜80 Ω/□ | −9.21 | −8.62 | −8.68 | −10.53 |

What is claimed that:

1. A near-field electromagnetic wave absorber consisting essentially of a conductive material, wherein the conductive material conductively acts on the electrical field component of the electromagnetic wave, and thereby the conductive material absorbs an electromagnetic wave within one wavelength from the electromagnetic wave source.

2. The near-field electromagnetic wave absorber according to claim 1 further comprising a substrate, wherein the conductive material is formed on the surface or inside of the substrate.

3. The near-field electromagnetic wave absorber according to claim 2, wherein the substrate comprises non-metallic materials.

4. The near-field electromagnetic wave absorber according to claim 1, wherein the surface resistivity of the surface of the conductive material ranges from 3 to 190 Ω/□.

5. The near-field electromagnetic wave absorber according to claim 1, wherein the surface resistivity of the surface of the conductive material ranges from 4 to 70 Ω/□.

6. The near-field electromagnetic wave absorber according to claim 1, wherein the surface resistivity of the surface of the conductive material ranges from 10 to 190 Ω/□.

7. The near-field electromagnetic wave absorber according to claim 1, wherein the surface resistivity of the surface of the conductive material ranges from 10 to 80 Ω/□.

8. The near-field electromagnetic wave absorber according to claim 1, wherein the conductive material comprise carbon-based materials.

9. The near-field electromagnetic wave absorber according to claim 1, wherein the conductive material has a form of powder, fine powder, lump, whisker, flat, or fiber.

10. The near-field electromagnetic wave absorber according to claim 1, wherein the conductive material comprises at least either of carbon nano-fiber or carbon nano-tube.

11. The near-field electromagnetic wave absorber according to claim 10, wherein the conductive material comprises carbon black or carbon graphite.

12. The near-field electromagnetic wave absorber according to claim 1, wherein the conductive material comprises at least carbon nano-fiber and the surface density of the carbon nano-fiber ranges from 0.3 to 9 mg/cm².
